(19) United States
(12) Patent Application Publication
(10) Pub. No.: US 2026/0310785 A1
(43) Pub. Date: Oct. 8, 2026

(54) DEVICES, SYSTEMS, AND METHODS FOR RANSOMWARE PROTECTION AND MITIGATION

(71) Applicants: Oceanit Laboratories, Inc., Honolulu, HI (US); The Regents of the University of Michigan, Ann Arbor, MI (US)

(72) Inventors: David Siu, Honolulu, HI (US); J. Alex Halderman, Ann Arbor, MI (US); Max Froehlich, Ann Arbor, MI (US); Steven Sprecher, Boston, MA (US); Ky Ho, Honolulu, HI (US); Wen Plotnick, Ann Arbor, MI (US)

(21) Appl. No.: 19/197,965

(22) Filed: May 2, 2025

Related U.S. Application Data
(63) Continuation-in-part of application No. 17/963,817, filed on Oct. 11, 2022, now Pat. No. 12,306,937.
(60) Provisional application No. 63/254,485, filed on Oct. 11, 2021.

(51) Int. Cl. G06F 21/55; G06F 21/60

(52) U.S. Cl. CPC G06F 21/554; G06F 21/602; G06F 21/606

(57) ABSTRACT

Disclosed herein are devices, systems, and methods for detecting, mitigating, and protecting against malicious actions and/or malicious computer software, including malware and ransomware. Specifically, disclosed embodiments mitigate the threat of ransomware across a wide range of devices including, for example, servers, storage systems, computers, and portable storage devices.

### CROSS-REFERENCE TO RELATED APPLICATIONS

This application is a continuation-in-part of U.S. application Ser. No. 17/963,817, filed Oct. 11, 2022, which claims priority to U.S. Provisional Application No. 63/254,485, filed Oct. 11, 2021, each of which is hereby incorporated by reference in its entirety.

### STATEMENT REGARDING FEDERALLY SPONSORED RESEARCH OR DEVELOPMENT

The invention described herein was made with U.S. government (“Government”) support under Contract No. W911NF-21-C-009, awarded by the U.S. Army. As a result, the Government has certain rights in this invention.

### FIELD

The disclosure relates generally to devices, systems, and methods for cybersecurity, including, for instance, ransomware detection, protection, and mitigation. In particular, embodiments of the disclosure detect and block malicious actions in a computer system or computing device, preserve important data before malicious software can destroy it, and the computer system or computing device has no visible agent, process, and/or software for malicious software to detect.

### BACKGROUND

By some estimates, the worldwide cybersecurity market was valued at $167 billion in 2020 and is expected to grow roughly 11% from 2021 to 2028. For instance, the U.S. Department of Defense cybersecurity budget was $6.7 billion in 2017, and is expected to almost triple to $18 billion by 2022. Cybersecurity spending in the oil and gas industries was expected to hit almost $2 billion by 2019.

Cybersecurity is also currently one of the highest-growth markets due to high-profile, large-scale attacks against leading companies, which need to protect their intellectual property. Moreover, cybersecurity is unique since almost all industries (e.g., healthcare, retail, entertainment, transportation, governments, militaries, etc.) require improved software and services, since existing products can be difficult to use and often do not protect against rapidly-evolving threats.

As a result, high demand for information security systems is expected to continue across a variety of industries and organizations, including, for instance, government agencies, military agencies, and private sector companies, due to enhanced threats from hackers, nation states, and criminals with increased access to automated tools and services.

Indeed, the number of stealthy, targeted, financially-motivated attacks is increasing. Many such attacks are aimed at exploiting vulnerabilities in endpoint devices. As a result, many companies and industries have an increasing awareness, and need, for a multi-layered seamless approach for ransomware protection. Signature-based antivirus and anti-spyware protection measures, which are traditionally provided by antivirus software, are not sufficient to deal with the current stream of constantly evolving cyberthreats.

Given the foregoing, there exists a significant need for devices, systems, and methods that can detect, mitigate, and protect against malicious actions, such as those executed by ransomware. In particular, there is a need for cybersecurity solutions that stealthily detect and block advanced ransomware strains, including those that are fileless, polymorphic, and employ state-of-the-art anti-analysis and anti-detection methods.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In certain embodiments, the disclosed embodiments may include one or more of the features described herein.

Embodiments of the present disclosure are directed towards devices, systems, and methods for mitigating malicious actions and/or processes, such as, for instance, those executed by ransomware. Specifically disclosed herein are methods, devices, and/or systems that mitigate the threat of ransomware across a wide range of devices including, for example, servers, storage systems, computers, and portable storage devices.

At least one embodiment of the disclosure that provides ransomware detection and mitigation is referred to herein as Advanced Rapid Mitigation of Ransomware (ARMOR). During normal operation of a computing device, ARMOR monitors writes from the computing device and journals any malicious encryption that occurs. The journal may, in at least one example, reside on additional data storage and be controlled independently of a computer operating system or system processor and/or operate, or be executed, beneath such operating system or system processor. Then, after an attack, ARMOR restores one or more original files from the additional storage by reversing malicious writes.

In at least one embodiment, after a computing device containing ARMOR is turned on, normal operation(s) proceed through the host operating system (“OS”). The host OS performs write logging to a data journal, which is one aspect of ARMOR. After a ransomware or other malicious attack, a reset procedure is initiated, which generally results in the data journal restoring data to a recovery OS.

In at least one embodiment, a data journal is used to recover data after a ransomware attack. In at least one example, for every write made to a storage device (e.g., a solid state drive (SSD)), the journal records at least the following information: (1) the logical block address (“LBA”) of the SSD that is written, (2) a copy of the data at this LBA before the write is made, and (3) a relative ordering of this write with respect to all other writes. As a result, a complete history of all writes made to the SSD over its history is maintained. When the computing device is powered on following the detection of a ransomware attack, ARMOR initiates a recovery mode in which the stored overwritten data in the journal entries is used to undo these malicious writes.

In at least one embodiment, the journal itself is composed of three parts, a Journal State section, a Journal Entries section and a Journal Data section. In at least one example, the Journal Entries section contains the metadata associated to each disk write, including, for instance, a section containing an LBA of a write, a section containing an LBA of logged data in the journal, and a section containing the size of the write.

In at least one embodiment, the first thing the computer runs after starting up is a specific and selected code that prompts the user to continue to the regular OS or, alternatively, the recovery OS, depending on the system state. In at least one example, the SSD is capable of concealing the contents of the disk. Any bootloader read from the SSD, even one overwritten by an attacker, is allowed to return only the contents of the ARMOR bootloader. The ARMOR bootloader is then used to bootstrap into a trusted image that is inaccessible to attackers.

In at least one embodiment, ARMOR uses the following method to guarantee that the machine boots into the trusted system after rebooting in recovery mode. First, all Extensible Firmware Interface (EFI) System Partitions (ESPs) on the disk are dynamically located, and all reads and writes to an ESP in the regular flash area are redirected to an ESP in the hidden flash area. If the computer attempts to read a logical block of the host ESP, the computer instead receives the first block of the recovery ESP via boot redirection. Then, when the recovery mode or recovery process is activated, a new entry is dynamically added into GUID Partition Table (“GPT”). This new entry is the recovery OS data, and states that a data partition (e.g., a Linux data partition) exists in a hard-coded arbitrary extent of logical blocks. Finally, any reads or writes to the arbitrary extent written in the GPT are redirected to a hidden recovery OS data partition. That is, any attempt to load a recovery OS in host data is instead redirected to the hidden recovery OS.

In at least one embodiment, the computer boots into a stock distribution after taking control of the boot process. The stock distribution is converted into an image after being installed into a partition. In at least one example, the image contains a simple graphical user interface, presenting the user with specific options, including choosing to restore from a specific recovery checkpoint, or booting back into the regular OS.

In at least one embodiment, a recovery method is disclosed that comprises reading the data journal on the SSD, determining whether writes from the data journal are compromised or unaffected, determining, for the compromised writes, the correct disk state for each LBA of the SSD, and correcting, by the data journal, the disk state of the SSD.

In at least one embodiment, a recovery method is disclosed that comprises querying the data journal firmware for a list of recovery points and selecting a recovery point from the list, querying, from the journal firmware, the entire contents of a data journal, storing each LBA that was overwritten by a write to the data journal as a compromised LBA, for each compromised LBA, iterating backward through all entries in the data journal that occurred before the recovery point to find the most recent journal entry that wrote to the compromised LBA, and, for each compromised LBA, issuing commands to the journaling firmware to restore the compromised LBA to the data written by the most recent journal entry that wrote to the compromised LBA, thereby restoring each compromised LBA to an uncompromised state.

At least one embodiment of the invention utilizes a separate cryptographic scheme that employs symmetric-key encryption and symmetric-key message authentication codes as primitives with replay resistance on top of them, thereby allowing authorized systems and the SSD to securely communicate with each other.

In at least one embodiment of the invention, arbitrary secrets for encryption keys are installed in a trusted environment on to the SSD before deployment and/or use by a user. Additionally, one or more such secrets can be securely transferred to one or more IT servers, so that an attacker cannot acquire them.

In at least one embodiment, an ARMOR framework facilitates, in a user-friendly manner, communication and control with ARMOR and/or computing devices on which ARMOR is installed. The at least one embodiment has a plurality of aspects and/or components, including ARMOR firmware, SSD on which the ARMOR firmware is installed, an ARMOR Management Panel (AMP), an ARMOR Firmware Manager (AFM), and an ARMOR Command and Control Server (AC2).

In at least one embodiment, ARMOR performs automated ransomware detection and data recovery, in addition to or instead of manual recovery. Accordingly, ARMOR can perform one or more of the following categories of ransomware detection: (1) signature-based detection, and (2) behavior-based detection. In at least one example, behavior-based detection comprises analyzing overwrites of files and/or analyzing the entropy (randomness) of data being written to the disk.

In at least one embodiment, various metrics are used to train a binary decision tree that labels any given second of activity as either normal behavior or suspicious behavior based on the metrics for that second. ARMOR then utilizes the binary decision tree, with points containing the aforementioned metrics and the labels “suspicious behavior” and “normal behavior.”

These and further and other objects and features of the invention are apparent in the disclosure, which includes the above and ongoing written specification, as well as the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIGS. 1A-1B show an Advanced Rapid Mitigation of Ransomware (ARMOR) system during normal operation (FIG. 1A) and file restoration operation (FIG. 1B), according to at least one embodiment.

FIG. 2 is a block diagram showing a general overview of ARMOR functions, according to at least one embodiment.

FIGS. 3A-3B show the different portions of a data journal (FIG. 3A), including a Journal Entries section, and different portions of the Journal Entries section (FIG. 3B), according to at least one embodiment.

FIGS. 4A-4C show various functions of ARMOR for ensuring that a computing device boots into a trusted system after rebooting in recovery mode, including boot redirection (FIG. 4A), the addition of a recovery operating system data entry into GUID Partition Table (“GPT”) (FIG. 4B), and redirection to a hidden recovery operating system (FIG. 4C), according to at least one embodiment.

FIG. 5 is an image of a graphical user interface showing specific recovery options, according to at least one embodiment.

FIG. 6 shows a block of code for reading the JournalState of a drive, according to at least one embodiment.

FIGS. 7A-7B show various recovery methods used by ARMOR, according to at least one embodiment.

FIGS. 8A-8B show an ARMOR framework (FIG. 8A), including a firmware manager, and additional details regarding one implementation of the framework manager (FIG. 8B), according to at least one embodiment.

FIG. 9 shows code for issuing a POST request with JSON content, according to at least one embodiment.

FIG. 10 is a block diagram of a computing system that includes ARMOR, according to at least one embodiment.

FIG. 11 is a block diagram of a computing device with ARMOR, according to at least one embodiment.

FIG. 12 an example of a computing system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

In general, the word “instructions,” as used herein, refers to logic embodied in hardware or firmware, or to a collection of software units, possibly having entry and exit points, written in a programming language, such as, but not limited to, Python, R, Rust, Go, SWIFT, Objective-C, Java, JavaScript, Lua, C, C++, or C#. A software unit may be compiled and linked into an executable program, installed in a dynamic link library, or may be written in an interpreted programming language such as, but not limited to, Python, R, Ruby, JavaScript, or Perl. It will be appreciated that software units may be callable from other units or from themselves, and/or may be invoked in response to detected events or interrupts. Software units configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. Generally, the instructions described herein refer to logical modules that may be combined with other modules or divided into sub-modules despite their physical organization or storage. As used herein, the term “computer” is used in accordance with the full breadth of the term as understood by persons of ordinary skill in the art and includes, without limitation, desktop computers, laptop computers, tablets, servers, mainframe computers, smartphones, handheld computing devices, and the like.

In this disclosure, references are made to users performing certain steps or carrying out certain actions with their client computing devices/platforms. In general, such users and their computing devices are conceptually interchangeable. Therefore, it is to be understood that where an action is shown or described as being performed by a user, in various implementations and/or circumstances the action may be performed entirely by the user's computing device or by the user, using their computing device to a greater or lesser extent (e.g. a user may type out a response or input an action, or may choose from preselected responses or actions generated by the computing device). Similarly, where an action is shown or described as being carried out by a computing device, the action may be performed autonomously by that computing device or with more or less user input, in various circumstances and implementations.

In this disclosure, various implementations of a computer system architecture are possible, including, for instance, thin client (computing device for display and data entry) with fat server (cloud for app software, processing, and database), fat client (app software, processing, and display) with thin server (database), edge-fog-cloud computing, and other possible architectural implementations known in the art.

Embodiments of the disclosure comprise methods, devices, and/or systems that mitigate the threat of ransomware across a wide range of devices including, for instance, computer servers, computer storage systems, cloud computing devices and/or servers, portable storage devices, and the like.

At least one embodiment of the disclosure supports a wide range of platforms (including, but not limited to, ARM, x86, etc.), computer operating systems (including, but not limited to, Windows, Linux, etc.), and computer hardware (including, but not limited to, hard drives, solid state disks, etc.). A skilled artisan will recognize that the ability to support hard drives is important since they are still sold in many entry level computers and account for more than 50% of data storage sold, as of 2019. Thus, embodiments of the present disclosure protect a wide range of computing devices (e.g., servers, desktops, laptops, etc.) as well as universal serial bus (USB), Thunderbolt, SCSI, etc. device firmware, thereby protecting a wide range of portable devices. As a non-limiting example, embodiments of the present disclosure can be placed into the firmware that controls the USB device or other storage media, which are non-limiting examples of additional storage 108, resulting in a universal solution that can protect previous (e.g., hard disk drive (HDD), compact disc (CD), digital video disks or digital versatile disks (DVD), etc.), current (e.g., NAND memory devices, NOR flash memory devices, etc.), and next-generation (e.g., phase-change and/or memristor) data storage devices and/or technologies.

As will be known to a skilled artisan, computer code analysis generally requires an in-depth understanding of the operational principles of the central processing unit (CPU). The notions of both general purpose and specialized registers, the distinction between different methods of memory access, and instruction execution pipelining, all inform and support the analysis of ransomware and/or other potentially malicious software. The CPU elements required for such analysis start with memory addressing and control branching. Understanding registers and their purposes is also required since these provide detailed insight into the current execution state of the CPU.

After the CPU architecture, the next basic concept that is needed for program understanding is the so-called “opcode” or the instructions from a binary that is executed by the CPU. An assembly language instruction is composed of an opcode and a number of operands. The operands refer to data or memory locations which are sources or destinations for the operation indicated by the opcode. The x86 instruction set can refer to memory and register locations in a number of ways. These are referred to as “addressing modes,” which include (1) register, (2) immediate, (3) direct, (4) offset, (5) indirect, and (6) base-index. The machine language encoding for different opcodes may contain variable numbers of bytes such that whether a memory byte is considered as part of one instruction or another depends on where one begins execution.

Further information regarding the functioning of computing systems are known in the art and additionally described, at least in part, in U.S. application Ser. No. 17/963,817, which is hereby incorporated by reference in its entirety.

The term “ransomware,” at least as used herein, refers to malicious software (which may also be referred to as “malware”) that can lock a user's computing device (e.g., desktop computer, laptop computer, smartphone, etc.) through encryption of stored data, thereby preventing access until a ransom is paid. Typically, ransomware utilizes strong cryptographic algorithms, making files extremely costly or near impossible to recover. Due to the high risk of incurring data loss, ransomware poses an extreme threat to various industries, including, for instance, security services and defense operations.

Current technologies have various flaws that fail to effectively mitigate the threat of ransomware and allow for effective recovery when critical data has been victimized. For instance, although there are many different known anti-virus solutions that can detect already known and identified ransomware, there is no end-to-end technology solution that fully mitigates the threat that new and existing ransomware strains pose to computer systems.

At least one embodiment of the disclosure, which may be referred to herein as Advanced Rapid Mitigation of Ransomware (“ARMOR”), comprises firmware into which sophisticated detection and journaling algorithms have been placed, as well as interface components that add additional layers of defense for rapid ransomware mitigation. Non-limiting examples of such mitigation will be described further below herein.

In at least one example, ARMOR is a drop-in replacement for solid state drives (SSD), thereby incorporating intelligent ransomware detection and mitigation algorithms into firmware to allow rapid recovery and restoration after an attack or infection. By placing ransomware detection into storage devices themselves, ARMOR creates an additional layer of defense that can quickly restore computers after infection, and that operates independently of the computer operating system. ARMOR may in various embodiments be resident inside any interface chip or computing device component, whether on a host computing device or on a peripheral device, such as, for instance, Serial Advanced Technology Attachment (SATA) controllers, universal serial bus (USB), flash firmware, or any other interface component. ARMOR further provides rapid recovery of data, unlike known anti-ransomware systems.

Serial Advanced Technology Attachment (SATA) is a computer communications bus that sits between a host computer and storage devices such as, for instance, hard disk drives (HDD) and solid state drives (SSD). At least one embodiment of the disclosure adds ransomware detection and mitigation capabilities into SATA controllers, thereby adding a layer of defense below the operating system, yet above lower-level devices that control, e.g., the actual flash memory as part of the Flash Translation Layer (FTL). In at least one embodiment, ARMOR can be controlled independently of a computer operating system or system processor and/or operate, or be executed, beneath such operating system or system processor. For instance, ARMOR may be controlled by a computer processor of one or more of the aforementioned storage devices.

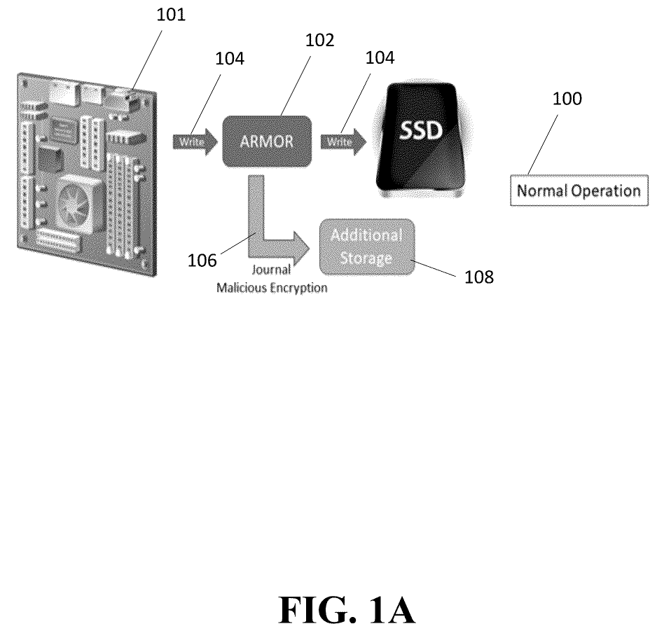

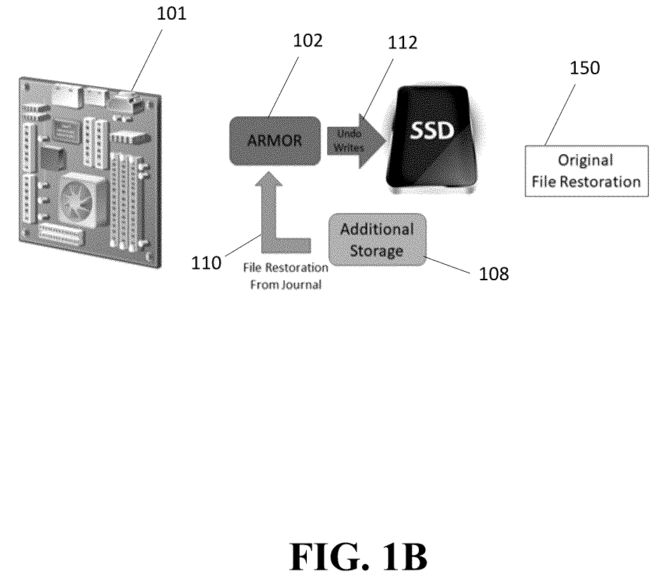

An overview of at least one example of ARMOR is shown in FIGS. 1A-1B. During normal operation 100, as shown in FIG. 1A, the ARMOR system 102 monitors writes 104 from computing device 101 and journals, at block 106, any malicious encryption that occurs. This journal resides on additional storage 108, which may be, for instance, a partition or portion of the drive itself, additional flash memory, and/or a memory card as part of a custom printed circuit board. Further, the journal may be controlled independently of a computer operating system or system processor and/or operate, or be executed, beneath such operating system or system processor. For instance, the journal may be operatively connected to, and controlled by, a computer processor of the additional storage 108 (e.g., a processor on a data storage device).

Then, after an attack, original file restoration 150 proceeds as shown in FIG. 1B. Specifically, the ARMOR system 102 restores, at block 110, one or more original files from the additional storage 108 by reversing malicious writes 112. The malicious writes are replaced with the one or more original files.

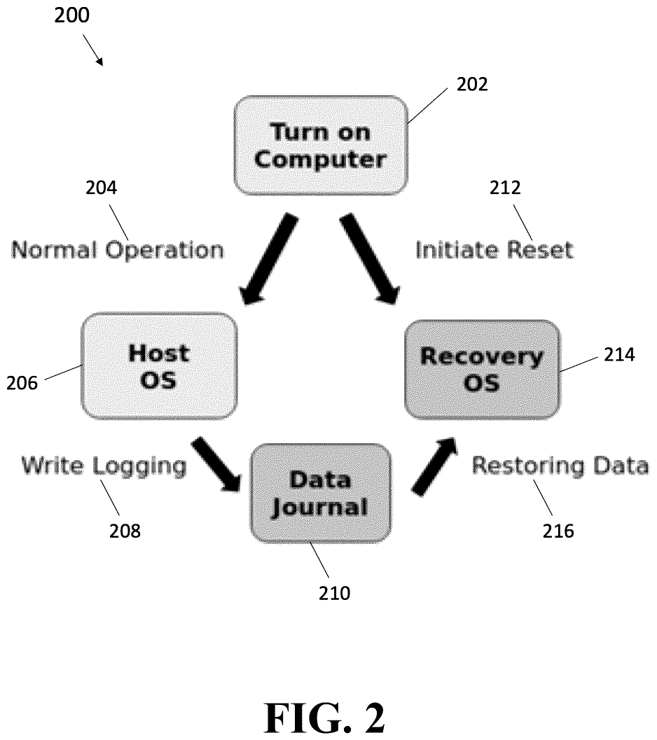

FIG. 2 is a block diagram 200 that shows a general overview of at least one example of ARMOR. As shown in block 202, after a computing device is turned on, normal operation(s) 204 proceed through the host operating system (“OS”) 206. The host OS performs write logging 208 to the data journal 210, which is one aspect of ARMOR. After a ransomware or other malicious attack, a reset procedure is initiated, as shown in block 212. This procedure generally results in the data journal 210 restoring data, as shown in block 216, to recovery OS 214.

Further details regarding various aspects, portions, and/or functions of at least one embodiment of the disclosure (e.g., at least one example of ARMOR) are discussed below herein.

### Data Journal

To recover data after a ransomware attack, a data journal containing separate copies of data made is recorded. The data journal can be any data journal described herein, including, for instance, journal 210. The journal allows for the recovery of data which has been overwritten by the ransomware attack.

For every write made to the SSD, at least the following information is recorded: (1) the logical block address (“LBA”) of the SSD that is written (i.e., the location on the SSD that was written to), (2) a copy of the data at this LBA before the write is made (i.e., the data that is overwritten), and (3) a relative ordering of this write with respect to all other writes (i.e., a monotonically increasing count of the number of writes made to the drive).

As a result, a complete history of all writes made to the SSD over its history is maintained. When the computing system is powered on following the detection of a ransomware attack, ARMOR initiates a recovery mode in which the stored overwritten data in the journal entries is used to undo these malicious writes, thereby restoring data to its original state (that is, the state of the data prior to the ransomware attack).

In at least one embodiment, journal entries can be stored in a ring buffer. Since storing every write can take up a large amount of storage space, deletion of the oldest journal entries can be handled implicitly by cyclically overwriting the journal entries. This means that the oldest backup data will start becoming unavailable when/if the buffer runs out of storage space.

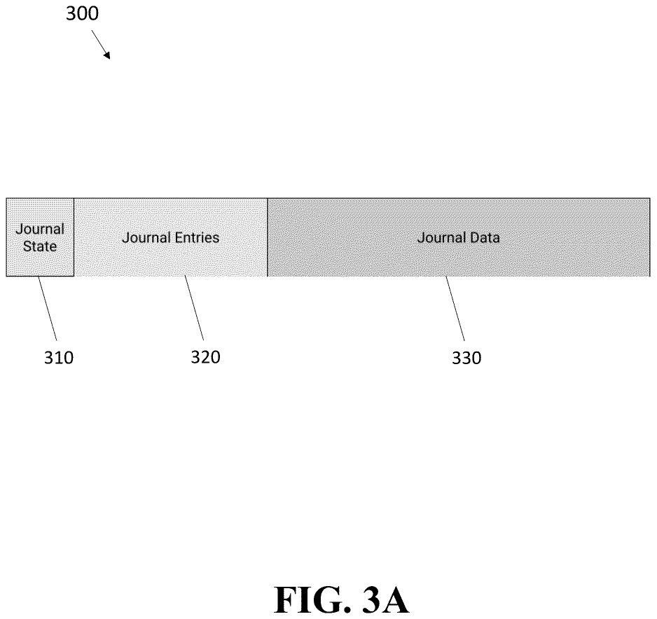

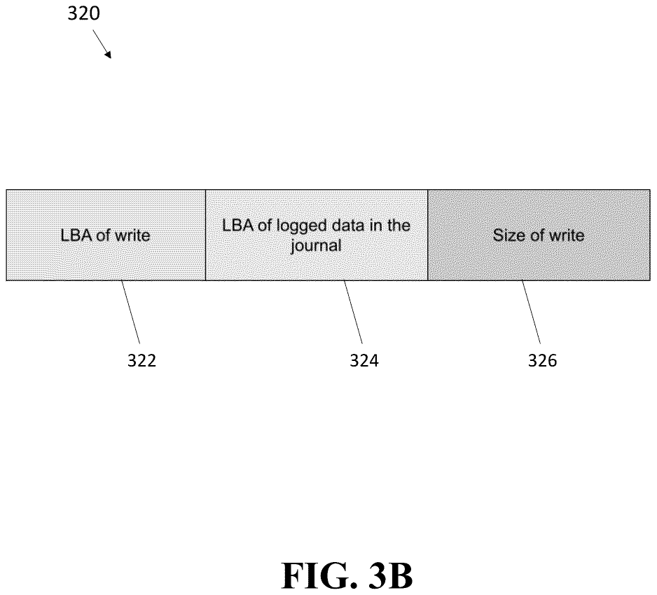

In at least one embodiment, the journal itself is composed of three parts, as shown in further detail in FIG. 3A. Journal 300 comprises section 310 (Journal State), section 320 (Journal Entries), and section 330 (Journal Data). The Journal State section 310 contains/stores all metadata about the journal, including all necessary metadata for the journal to be used and updated. The Journal Entries section 320 contains data for each write issued to the drive. Finally, the Journal Data section 330 contains a copy of the data being written to the drive, which can be used later in the data recovery process.

Journal State section 310 stores LBAs for where each of the other two sections are stored in the SSD's reserved area, as well as data regarding how full these sections are. In at least one example, such information is used for the placement of new data from an incoming write.

In at least one example, Journal Entries section 320 further contains the metadata associated to each disk write, which is shown in FIG. 3B. Specifically, Journal Entries section 320 contain section 322 (an LBA of a write), section 324 (an LBA of logged data in the journal), and section 326 (the size of the write). In each journal entry, section 322 stores the LBA to which the write was issued, section 324 stores the location of the corresponding data in the Journal Data section 330 of the journal, and section 326 stores the size of the write in sectors.

The Journal Data section 330 is a data portion of the drive. In at least one example, data is stored as blocks of contiguous memory in this section. These blocks are pointed to by a “LBA of logged data in the journal” field in journal entry (e.g., in section 324).

To update the journal, a WriteDataCallback is registered, which is executed by the firmware on every disk write. This callback function receives the LBA of the original write and the number of sectors of the write. As a result, all the data needed to update the journal and to copy the data to be stored is available to the callback function. A corresponding journal entry for this write and the metadata from the journal state is used to determine the location in the reserved area to which this metadata and duplicated write should be written. Finally, the journal state itself is updated, if needed, and written to the disk.

### Hidden Recovery OS

To recover a system's files, a malware-infected computer needs to be returned to a state where it can run trusted code to give the user options for recovery or make that recovery possible. In at least one embodiment, the first thing the computer runs after starting up is a specific and selected code that prompts the user to continue to the regular OS or, alternatively, the recovery OS, depending on the system state. This recovery OS can be any recovery OS described herein, including, for instance, recovery OS 214.

However, malware with administrative privileges can change boot options arbitrarily. Thus, an attacker could change the boot order or overwrite the ARMOR bootloader with their own, circumventing the recovery process.

In at least one embodiment, a solution to the above issue is implemented as follows: The SSD is capable of concealing the contents of the disk. Any bootloader read from the SSD, even one overwritten by an attacker, is allowed to return only the contents of the ARMOR bootloader. The ARMOR bootloader is then used to bootstrap into a trusted image (e.g., a Linux image) that is inaccessible to attackers. In at least one example, such image exists “on top” of the actual disk contents. This arrangement does not preclude the use of secure boot, a common boot security mechanism in computing firmware.

### The Unified Extensible Firmware Interface (UEFI) Boot Process

Modern computers all boot following the UEFI specification, which outlines the standard way for computers to locate potential bootable items and boot from them. On power-up, the motherboard firmware reads UEFI variables from non-volatile random-access memory (“NVRAM”), which are used to control the boot process. Within the UEFI variables are boot entries, from which the firmware will attempt to boot in a specified order, assuming the entries are valid.

For a partition located on a storage medium to be acceptable for use with a specific boot entry, the number, format, globally unique identifier (GUID), start, and extent all must match. If some partition does match, it is considered valid for the boot entry even if the actual disk contents of the specified partition file system are entirely different, or the storage device itself is different.

If the SSD spoofs having bootloaders for all specified boot entries, then the OS being loaded is indistinguishable from what was intended to be loaded. For instance, Secure Boot only prevents booting from bootloaders that were not transitively signed from a trusted root user, so a valid Windows bootloader can be silently replaced with a bootloader (e.g., a Linux bootloader).

Since UEFI boot variables cannot be read by the SSD firmware, ARMOR discovers boot entries, in at least one embodiment, through the following two processes.

First, ARMOR may attempt to create paths for “common” boot entries. For example, a typical Windows install will boot into Extensible Firmware Interface (EFI)/Microsoft/Boot/bootmgfw.efi, so the EFI binary placed at that file path is likely to be loaded. Similarly, entries can be created in fallback paths that can be tried when/if the UEFI firmware fails all others, e.g. a fallback basic input/output system (BIOS) boot entry. For this approach, a statistically generated replacement EFI System Partition (“ESP”) is used, as described further below herein (e.g., in the “ARMOR Boot Partition Redirection” section). This statistically generated replacement ESP is one to which all host ESPs are redirected.

If the aforementioned attempt is insufficient, ARMOR may search the EFI System Partitions on the original disk, which are readable since they are formatted in, e.g., FAT12/FAT16/FAT32. ARMOR may attempt to find any data in the format of an EFI binary. Every original path is then cloned with a fake version, assuming that the existing boot entries trying to boot any particular EFI binary would load the desired code instead. In at least one example, the ability to read and and write to EFI System Partition file systems is provided via a ported version of ChaN's FatFS library and ARMOR is configured to automatically locate all potential UEFI executables within a given ESP. This approach requires a suitable “fake” ESP to be generated at runtime.

### ARMOR Boot Partition Redirection

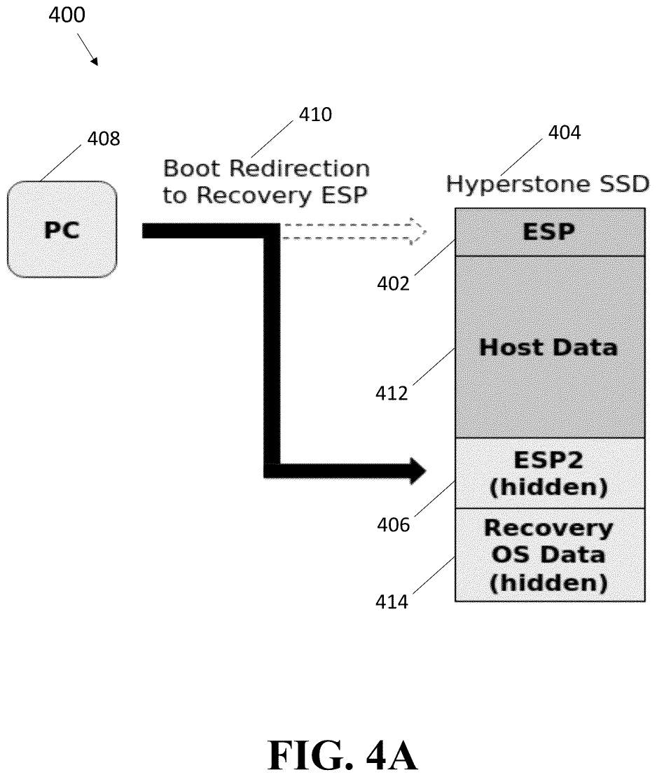

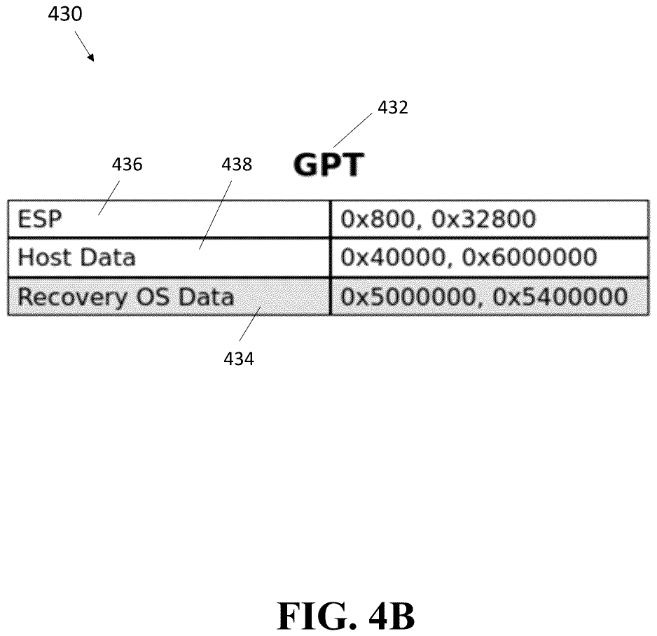

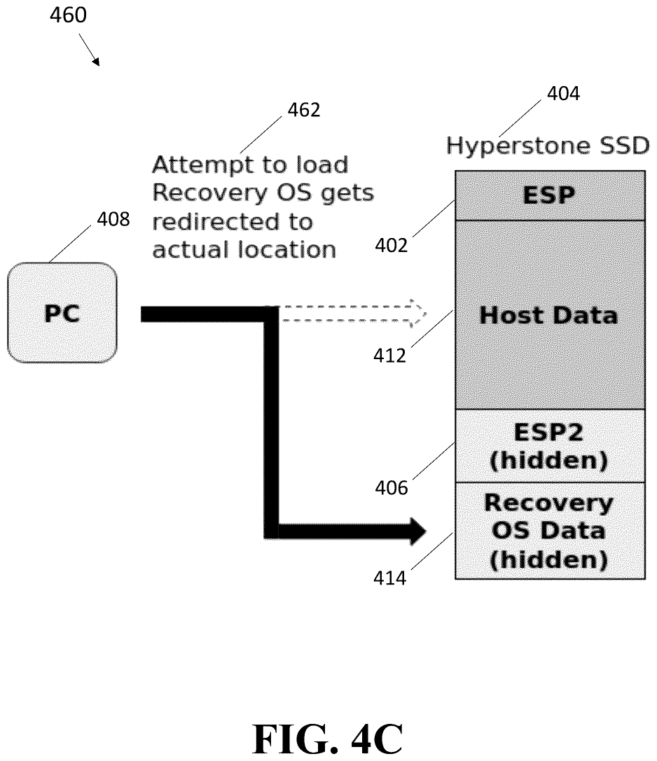

In at least one embodiment, and as shown in further detail in FIGS. 4A-4C, ARMOR uses the following method to guarantee that the machine boots into the trusted system after rebooting in recovery mode.

First, as shown in diagram 400 of FIG. 4A, all ESPs on the disk are dynamically located, and all reads and writes to an ESP 402 in the regular flash area (e.g., in SSD 404, which also contains host data 412) are redirected to an ESP in the hidden flash area (e.g., hidden ESP 406). If the computer 408 attempts to read logical block 1 of the host ESP 402, the computer instead receives the first block of the recovery ESP (that is, ESP 406) due to boot redirection 410. Essentially, ARMOR “replaces” the ESP 402 entirely without actually modifying the contents on the disk.

Then, as shown in diagram 430 of FIG. 4B, when the recovery mode or recovery process is activated, a new entry is dynamically added into GUID Partition Table (“GPT”) 432. This new entry is the recovery OS data 434, and states that a data partition (e.g., a Linux data partition) exists in a hard-coded arbitrary extent of logical blocks.

In at least one example, the recovery ESP 406 contains a distribution-signed Grand Unified Bootloader (GRUB); accordingly, the recovery ESP is compatible with Secure Boot. In at least one example, GRUB only loads an OS if the OS's data partition is present in the disk's GPT. The GPT 432 is a ledger that defines the locations of partitions on the disk (e.g., ESP 436 and host data 438), which is always present at fixed locations in the disk. When not in recovery mode, the data partition can be hidden by removing any mention of the partition in the GPT.

Then, as shown in diagram 460 of FIG. 4C, any reads or writes to the arbitrary extent written in GPT 432 are redirected to the hidden recovery OS data partition 414. That is, any attempt 462 to load a recovery OS in host data 412 is instead redirected to the hidden recovery OS 414. Also shown in FIG. 4C are the same ESP 402, SSD 404, hidden ESP 406, and computer 408 as shown in FIG. 4A. In at least one example, the hidden recovery OS data partition 414 is hardcoded to start at 0x20000000000, or about 20 gigabytes (GB) into the disk, since it is unlikely for an ESP to be located in such a location.

### User Interface

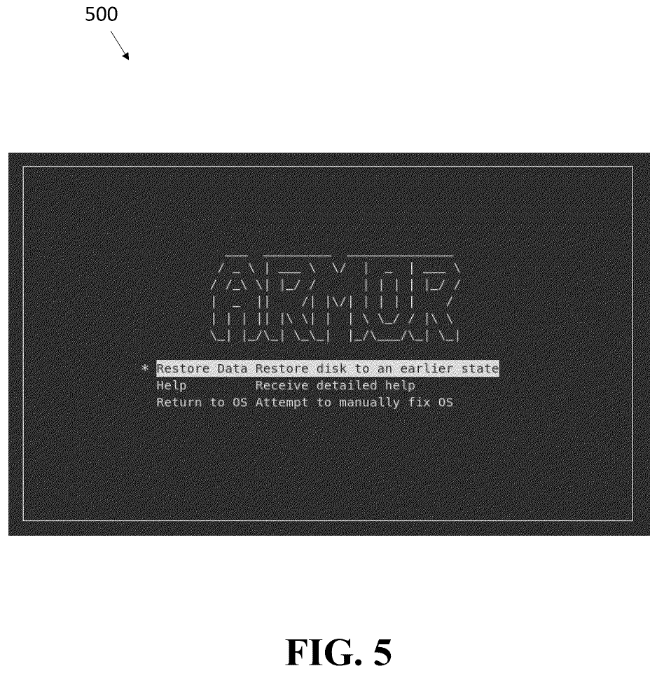

In at least one embodiment, the computer boots into a stock distribution (e.g., a stock Linux distribution such as Debian) after taking control of the boot process. The stock distribution is converted into an image after being installed into a partition (e.g., a 5 GB partition). On this image, a simple graphical user interface opens, presenting the user with specific options, including choosing to restore from a specific recovery checkpoint, or booting back into the regular OS. A non-limiting example of the simple graphical user interface 500 is shown in FIG. 5. In order to ensure that this image is the first thing a user sees upon boot, a custom systemd unit can be used in at least one example. This unit replaces the typical getatty@ttys1 provider that would normally display a login screen.

Communication with the Data Journal

On booting, the recovery OS must communicate with the data journal's firmware in order to use the journal to perform a recovery.

In at least one embodiment, the host sends a command (e.g., a 512-byte command) through the vendor command to the firmware, where the firmware processes the command and prepares the necessary data or status response. The host can then issue a firmware-to-host transfer vendor command and receive the response prepared by the firmware. Necessary commands for recovery may include, for instance: (1) reading the overall journal state, (2) reading the logged journal entries, and (3) instructing the firmware to replay a sub-section of a journal entry.

In at least one example, replaying a journal entry comprises overwriting the portion of the drive with the correct data stored in the journal. Additionally, a command may be required to tell the firmware to enter recovery mode, and/or commands that can read states held by the firmware.

In at least one embodiment, journal commands are defined as a 512-byte structure that comprises a 4-byte opcode. The opcode may determine which command to run, followed by optional auxiliary data. In the event that the index of the journal entry is incorrect or the LBAs are out of range, the firmware returns an error code in the subsequent firmware-to-host vendor command, or otherwise returns 0.

There are at least two options to issue such vendor commands from a host computer. First, Advanced Technology Attachment (ATA) Read Log Ext/Write Log Ext commands can be used. The ATA specification provides a unified mechanism for the firmware of a drive to expose logs to a host for reading or writing. By issuing a Read Log Ext or Write Log Ext command to specified logs, the firmware can execute the corresponding vendor commands. Second, Vendor Command Tunnel can also be used to issue commands.

In at least one embodiment, the aforementioned options are implemented as follows.

### Small Computer System Interface (SCSI) ATA Passthrough (e.g., Linux)

Linux can expose the ability to execute ATA commands by the SCSI ATA Command Pass-through standard (T10/04-262r7). The sg3_utils library provides functions to open a device for SCSI command issuing and to issue SCSI commands. In at least one embodiment, ARMOR subsequently prepares the command data buffer for the SCSI command and wraps the functions provided by sg3_utils.

### IOCTL_ATA_PASS_THROUGH_DIRECT (e.g., Windows)

Windows provides a direct system call for executing ATA commands, specifically the “IOCTL_ATA_PASS_THROUGH_DIRECT” directive for the system call “DeviceIoControl”. In at least one embodiment, this system call is used and the requisite buffers containing the data of the “Read_Log_Ext” and “Write_Log_Ext” commands are prepared so that vendor commands can be executed on the Windows host.

### Vendor Command Tunnel (e.g., Linux, Windows)

In at least one embodiment, a vendor command tunnel is opened with a specific pattern of reads to adjacent LBAs of the drive, followed by a write containing configuration information for the tunnel. The firmware subsequently interprets any reads or writes to these LBAs as executing vendor commands specified in the initial configuration. To avoid possible overwriting of disk data, a dummy file is created and the LBAs occupied file is used for communication.

Once opened, the tunnel executes the required vendor commands for verifying that the tunnel was successfully opened and for executing ARMOR commands. Windows and Linux handle block devices slightly differently; the Windows implementation requires a filesystem to exist on the drive to create a file in which to open the tunnel, while the Linux implementation can open the tunnel at arbitrary LBAs, and so a tunnel can be created even on non-partitioned drives.

### Library Interface

Rather than expose the direct vendor command functions to users of the library, such as the Windows driver and the Recovery OS, ARMOR may, in at least one embodiment, expose an abstract “VC_Issuer” and “ARMOR_Issuer” class. A VC_Issuer is an implementation of one of the above methods to issue vendor commands. An ARMOR_Issuer then takes a VC_Issuer and uses it to execute and parse the output of ARMOR commands. This allows users of the library to easily interface with ARMOR commands without navigating the lower-level details of the vendor command interface.

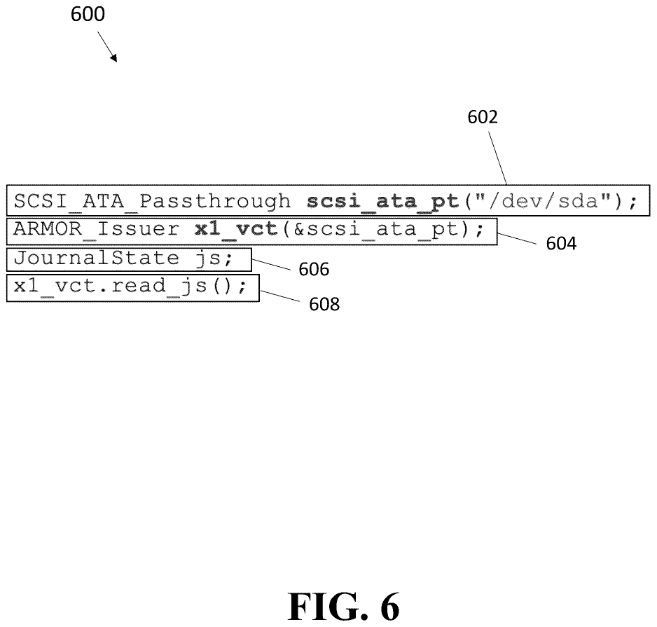

FIG. 6 shows a non-limiting example of code 600 for reading the JournalState of a drive. The first line 602 initializes a SCSI_ATA_Passthrough object, which implements VC_Issuer. The second line 604 creates the ARMOR_Issuer using this SCSI_ATA_Passthrough object. The remaining lines 606 and 608 then read the journal state of the drive. Importantly, the caller of the read_js function does not need to parse the raw data returned by the vendor command into a JournalState object.

### Recovery Process

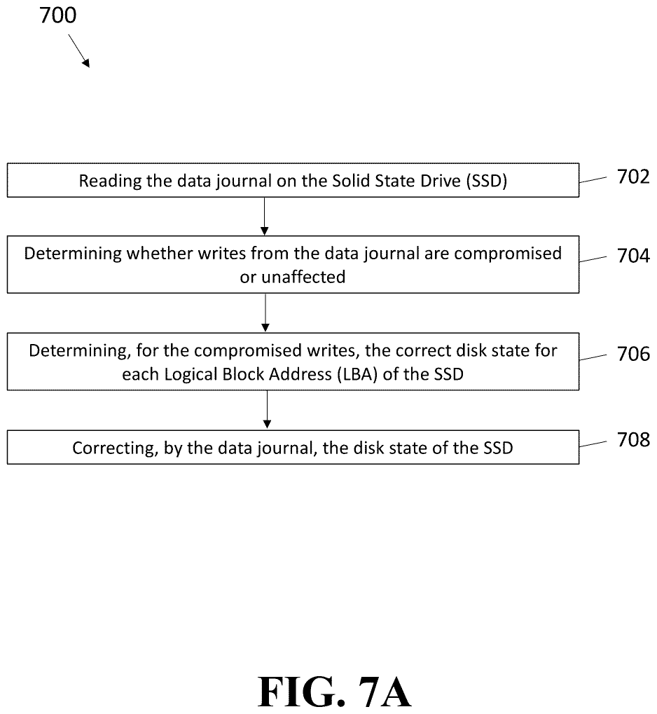

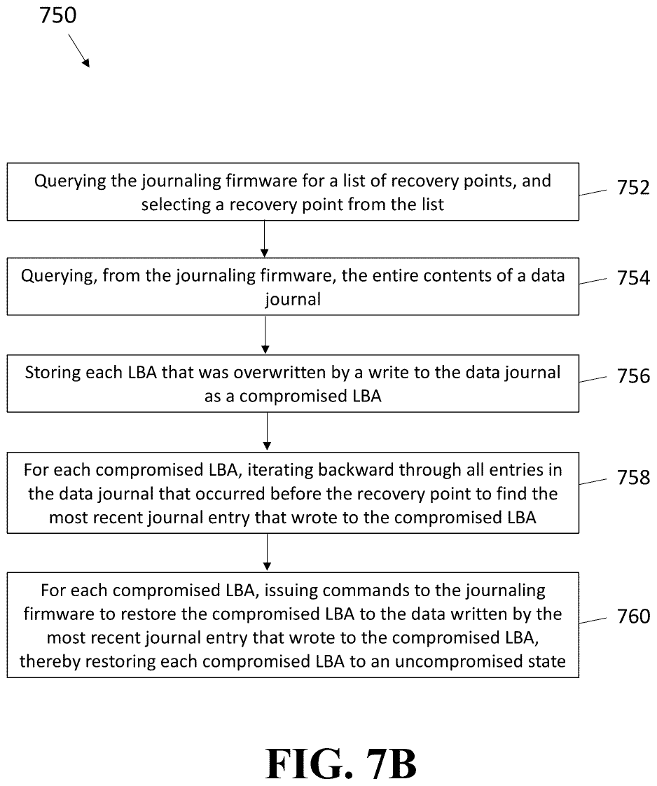

Turning now to FIG. 7A, a recovery process 700 according to at least one embodiment is shown. First, at block 702, the data journal stored on the SSD is read. Then, at block 704, writes from the data journal are determined to be either compromised or unaffected. Then, at block 706, for compromised writes, the correct disk state for each LBA of the SSD is determined. Finally, at block 708, the disk date of the SSD is corrected using the data journal.

FIG. 7B is a block diagram of a recovery process 750 used by ARMOR, according to at least another embodiment of the invention. First, at block 752, ARMOR queries the journaling firmware for a list of recovery points and selects a recovery point from the list of recovery points. Then, at block 754, ARMOR queries the entire contents of the journal from the journaling firmware. Then, at block 756, ARMOR stores, as a compromised LBA, each LBA that was overwritten by a write to the journal after the recovery point. Then, at block 758, for each compromised LBA, ARMOR iterates backwards through all journal entries before the recovery point to find the most recent (relative to the recovery point) journal entry that wrote to the compromised LBA. Finally, at block 760, for each compromised LBA, ARMOR issues commands to the journaling firmware to restore the compromised LBA to the data written by the most recent journal entry (prior to the recovery point) that wrote to the compromised LBA. This process results in ARMOR containing the data at the compromised LBA at the recovery point, and then restoring the original, uncompromised data.

Preventing Malware from Abusing the Recovery Process(es)

Once the user has decided to restore an earlier state of the computer, the recovery OS, in at least one embodiment, sends a message to the SSD firmware to initiate recovery. Communication with the SSD is limited to vendor-defined commands and responses from these commands. However, malware with administrative privileges can also send vendor commands, meaning the firmware must be able to verify that commands sent to the SSD originate from a trusted source.

Known cryptography methods with symmetric-key message-authentication codes are insufficient because an attacker can store valid signed commands and re-send them, which would allow the attacker to defeat the recovery mechanism by writing old data at will.

Accordingly, at least one embodiment of the invention utilizes a separate cryptographic scheme that employs symmetric-key encryption and symmetric-key message authentication codes as primitives with replay resistance on top of them, thereby allowing authorized systems and the SSD to securely communicate with each other. This ensures that the authorized systems and the SSD are only receiving current/valid messages.

A malicious program can act as an infected computer's administrator user, thereby allowing the program to disrupt operation of the computer in various ways, including, but not limited to, arbitrarily inspecting and modifying network packets, sending and/or blocking reads, writes, and/or vendor commands, and the like. The computer may also be in a state in which a user finds it difficult or impossible to directly run programs (e.g., a program to instruct the SSD to enter recovery mode). To avoid this problem, at least one embodiment of the invention uses a remote information technology (IT) server, which is a trusted server that is in an uncompromised (that is, malware- and virus-free) state. The IT server has the ability to tell misbehaving remote computers to restore to a previous state. For instance, the server is configured to communicate with the SSD and send the SSD various commands, including, for example, that the SSD should enter into recovery mode.

In at least one example, the server has a trivial OS background service that relays remote messages to SATA commands, which itself is untrusted (that is, there are no security issues if an attacker disables and/or modifies the background service). The remote IT server can also remotely inquire about the status of a given computer (e.g., if ARMOR thinks ransomware may be present, update one or more components of ARMOR, and/or remotely restore a computer to a previous state without a user being present).

In at least one example, a communication channel between the IT server and the SSD is (1) encrypted such that attackers viewing in-flight data cannot make any inferences about such data, (2) authenticated both ways (e.g., the IT server can have a guarantee that received messages came from the SSD and vice-versa, meaning that an attacker cannot inject valid commands), and (3) reply-resistant in both directions, thereby preventing an attacker from spuriously telling the IT server that an infected computer is not infected, and preventing the attacker from maliciously reissuing a previously validly-signed command).

In at least one example, the primitives used comprise SHA256 and AES-CBC primitives that are provided through specific firmware application programming interfaces (APIs) (e.g., Hyperstone's firmware API). Replay resistance can be accomplished via a “nonce handshake,” a known process where the IT server and the SSD use randomly generated nonces to bootstrap the establishment of a shared session nonce. The shared session nonce is then used in a Transmission Control Protocol (TCP)-like established stream for bidirectional communication, where every new message contains a signed version of the session nonce and the sequence number.

In at least one example, commands sent to the SSD that are accepted and processed are also authenticated. This prevents an arbitrary third party from sending new commands that are accepted as valid and run. A skilled artisan will recognize that many commands that are helpful to a genuine user can be incredibly harmful if run by an attacker. For example, a command telling the computer to enter into Manual Recovery mode, where the system explicitly does not enter recovery mode automatically, would enable a virus or malware complete control over the computing system.

Additionally, commands authorized by a trusted authority should not be replayable or reorderable. For instance, if command “A” was accepted in the past, simply replaying “A” in the future should not result in its acceptance. Similarly, if a host intends for command “A” to be run, followed by “B,” there should be no scenario in which an attacker can intercept the sent messages and somehow trick the system into running “B” first, followed by “A.”

Further, an attacker or adversary should not be able to tell the effects of a given command by inspecting the encrypted contents. The attacker should also not be able to differentiate between different types of encrypted commands (e.g., a hypothetical Health Check Status Get command verses an Enter Recovery Mode command) by inspecting them. Such differentiation would allow a smart virus or malware to selectively drop certain commands that would be harmful to it if those commands were executed.

In at least one embodiment of the invention, arbitrary secrets are installed in a trusted environment on to the SSD before deployment and/or use by a user. Additionally, one or more such secrets can be securely transferred to one or more IT servers, so that an attacker cannot acquire them.

In at least one example, the aforementioned API provides (1) a good implementation of the SHA-256 hash in ‘hyhash.h’, (2) a good source of randomness in the ‘hyrng.h’ functions, which may be based on ring oscillators sampled with the system clock, and then XORed together to form a random bit stream, and (3) an implementation of AES128/AES256 in ECB, CBC, or XTS mode in ‘hyencryption.h’.

In at least one embodiment of the invention, the commands for communicating with the SSD (both reading and writing) are sufficiently privileged and/or secure, which can be achieved through the use of an arbitrary number of IT servers and known methods, such as, for instance, Hypertext Transfer Protocol Secure (HTTPS) between valid IT server identities that can be pre-installed on the computing device(s) to be protected. Accordingly, if the background service on a given computer is functioning normally, an attacker does not have the ability to inject, modify, or even view the contents of messages sent from the IT server into the background service. Additionally, random commands will not be dropped in either direction of communication unless complete network failure occurs for an extended period of time.

In at least one example, both the IT server(s) and the SSD are securely provided with a shared, identical cryptographically random key (e.g., a 256-bit cryptographically random key). In the aforementioned at least one example, the SSD, IT server, and other components are defined as follows:
C: The SSD.
S: The IT server.
K: The shared random key described above.
HMAC_{X} [m]: The output of performing standard RFC 2104 HMAC-SHA256 on the message m using the key X.
ECB_{X} (m): The output of performing AES256-ECB on the message m using the key X, assuming m is already padded to a multiple of the block size.
CBC_{X,Y} (m): The output of performing AES256-CBC on the message m using the key X and IV Y, assuming m is already padded to a multiple of the block size. The result does not have the IV at the start, despite it frequently being there.
nₛ: a 16-Byte nonce generated by the IT server at certain points specified later, and used by the SSD and IT server for initiating a new open session.
n_{c}: a 16-Byte nonce generated by the SSD at specific points specified later, and used by the SSD and IT server for initiating a new open session.
nₛₑₛₛ: a per-open-session 16-Byte nonce set at specific points specified later.
k^{E}_{C->S}, k^{H}_{C->S}, k^{E}_{S->C}, and k^{H}_{S->C}: Using the RFC 5869 section 2.3 definition, these are 256-bit-long values T(1), T(2), T(3), and T(4) from the KDF using a zero-length info field, K as the PRK, and performing only the Expand and not Extract steps. k^{E}_{C->S} is the encryption key used from communication from C to S, k^{H}_{C->S} the hmac key used for integrity of said communication, and k^{E}_{S->C} and k^{H}_{S->C} are the natural equivalents for communication the opposite direction.
A∥B: The result of concatenating the bytes B after A.
rₛ and r_{c}: 16-Byte-long random IVs generated at specific points specified later, used to make the AES-CBC encrypted commands indistinguishable to an external observer.
jₛ and j_{c}: Per-session 8-Byte sequence integers defined later. Whenever used in the scheme in a byte-wise fashion, these treated as Big-Endian numbers.
j_{s,exp} and j_{c,exp}: Per-session 8-Byte sequence numbers held by C and S respectively, and used by each to track the expected next sequence number to arrive from the other side.
uₛ: An 8-Byte UID on the IT server assumed to be truly unique per server. The UID containing exclusively 0s when represented in binary form is reserved for internal use and is not used.

C contains a hashtable or other data structure uniquely mapping 8-Byte UIDs (active session UIDs) to the following set of state: the j_{s,exp}, j_{c}, and nₛₑₛₛ associated with the active session tied to that UID.

Before communication can happen between either side, a new active session must be established between the two using the following steps, as shown in Table 1 below. Specifically, a cryptographic scheme is shown that includes session-based synchronization and acknowledgement messages.

TABLE 1
Non-limiting example of a session of the ARMOR secure channel.

| | |
|---|---|
| S | C |

S communicates first nonce to C

nₛ <-$ {0, 1}¹²⁸
nₛ -> Nonce-SYN

C communicates nonce to S

| | |
|---|---|
| | c <- n_{c} |
| | t <- HMAC k^{H}_{C->S} (c\|\|nₛ) |
| | Nonce-SYN-ACK <- c\|\|t |
| Verify HMAC k^{H}_{C->S} (c\|\|nₛ) = t | |
| If verification failed, abort | |
| nₛ <- c | |
| nₛ <-$ {0, 1}¹²⁸ | |
| nₛₑₛₛ <-$ {0, 1}¹²⁸ | |
| jₛ <- 0 | |
| J_{c, exp} <- 0 | |

S sends session nonce to C

c <- uₛ|nₛₑₛₛ
t <- HMAC k^{H}_{C->S} (c||n_{c})
c||t -> Nonce-ACK

C creates local session tracking data

Verify HMAC k^{H}_{S->C} (c||n_{c}) = t
If verification failed, wait for new message
Otherwise establish session between C and uₛ
uₛ||nₛₑₛₛ <- c
Clear previous state associated with uₛ
Session[uₛ].j_{s,exp} <- 0
Session[uₛ].j_{c} <- 0
Session[uₛ].nₛₑₛₛ <- nₛₑₛₛ

Specific details of the aforementioned steps are described as follows.
Step 0. C has already generated n_{c} from some source of hardware entropy at boot or regenerated it at a specified point. Similarly, S generates a new nₛ.
Step 1. Nonce-SYN: S sends the following message to C: nₛ
Step 2. Nonce-SYN-ACK: Whenever C receives a Nonce-SYN message from S, it responds with the following message, using the nₛ received: n_{c}∥HMAC k^{H}_{C->S} [n_{c}∥nₛ]
Step 3. Nonce-ACK: S verifies the Nonce-SYN-ACK response by verifying that the hmac sent matches its own calculation of the hmac generated from the first segment of message and the value of nₛ held by it. If there is no match, S returns to the start, which lets S know that it has truly reached the SSD. If there is a match, S retrieves the current n_{c} from the first part of the message. S then regenerates nₛ from a source of hardware entropy. S then generates rₛ and nₛₑₛₛ from a source of hardware entropy. S then sets its sequence number jₛ to 0 and j_{c,exp} to 0. S then sends the following message to C, to finalize the opening of a new session for its UID using the generated session nonce nₛₑₛₛ: uₛ∥nₛₑₛₛ∥HMAC k^{H}_{S->C} [uₛ∥nₛₑₛₛ∥n_{c}]
Step 4. Session Create: Whenever C receives a Nonce-ACK message from S, C first verifies that the HMAC generated from the first portion of the message and the current value of n_{c} matches the second portion of the message. If there is no match, C stops and waits for other messages from S. If there is a match, a new session is established between C and S, termed uₛ. Then, n_{c} is immediately regenerated from a source of hardware entropy.

The following steps are then performed by C to set up the necessary state required to track this connection:

First, if there is already state associated with an open session C has with the UID uₛ, C clears this state, effectively “closing” the old connection.

Second, C creates an area for new session state tied to the session identified by uₛ in a hashmap-esque structure.

Third, C sets the j_{s,expected} and j_{c} of that state both to 0.

Fourth, C sets the nₛₑₛₛ of that state to the value of nₛₑₛₛ received from the message.

At this point, a session is established between C and S, using the unique UID us as identification. Arbitrary messages can now be sent from either party to the other at any time, as shown in Table 2 below.

TABLE 2
Non-limiting example of S messaging to C in an ARMOR secure channel.

| S | C |
|---|---|
| msg <- some message | |
| if jₛ+1 overflows, end session | |
| rₛ <-$ {0, 1}¹²⁸ | |
| c <- rₛ\|\|CBC.Enc K^{E}_{S->C}, rₛ (msg)\|\|uₛ\|\|jₛ | |
| t <- HMAC k^{H}_{S->C} (c\|\|nₛₑₛₛ) | |
| c\|\|t -> Message-ITS | |
| jₛ <- jₛ+1 | |
| | rₛ\|\|d\|\|uₛ\|\|jₛ <- c |
| | Verify: |
| | Session[uₛ] is open |
| | jₛ = Session[uₛ].j_{s,exp} |
| | HMAC k^{H}_{S->C} (c\|\|Session[uₛ].nₛₑₛₛ) = t |
| | If any fail, abort |
| | Session[uₛ].j_{s,exp} <- Session[uₛ].j_{s,exp}+1 |
| | msg <- CBC.Dec K^{E}_{S->C}, rₛ (d) |

Specifically, when S wants to send a new message msg to C, S first generates rₛ from a source of hardware entropy. S then sends to C the following: rₛ∥CBC k^{E}_{S->C},rₛ (msg)∥uₛ∥jₛ∥HMAC k^{H}_{S->C} [rₛ∥CBC k^{E}_{S->C},rₛ (msg)∥uₛ∥jₛ∥nₛₑₛₛ]. After sending the message, S increments its held sequence number jₛ. In the event that incrementing this number would cause an integer overflow to occur, S must establish a new active session with C before being able to send any further messages.

When C receives a message of the above type from S, C first checks if the sent UID uₛ is associated with an active session. If there is no association, C immediately stops and waits for further messages. If there is an association, C retrieves the stored state associated with the UID and, in at least one example, performs the following two checks to verify the integrity and authenticity of the received message. First, C checks that the sent sequence number jₛ matches the stored expected sequence number j_{s,exp}. Second, C checks that the HMAC sent generated from the first part of the message and its stored value of nₛₑₛₛ associated with the session matches what was sent in the second part of the message.

If there is a match, C knows that the received message is valid and increments its value of j_{s,exp} in preparation of the next one. C then uses the received rₛ to decrypt the AES-CBC-encrypted message and receive the msg inside, handling the contents as desired.

Table 3 below shows an example of C messaging to S.

TABLE 3
Non-limiting example of C messaging to S in an ARMOR secure channel.

| S | C |
|---|---|
| | msg <- some message to uₛ |
| | if Session[uₛ].j_{c}+1 overflows, end session |
| | r_{c} <-$ {0, 1}¹²⁸ |
| | c <- rₛ\|\|CBC.Enc K^{E}_{C->S}, r_{c} (msg)\|\|uₛ\|\| |
| | Session[uₛ].j_{c} |
| | t <- HMAC k^{H}_{C->S} (c\|\| Session[uₛ].nₛₑₛₛ) |
| | Message SSD <- c\|\|t |
| | Session[uₛ].j_{c} <- Session[uₛ].j_{c}+1 |
| r_{c}\|\|d\|\|uₛ\|\|j_{c} <- c | |
| Verify: | |
| u=uₛ | |
| j_{c} = j_{c,exp} | |
| HMAC k^{H}_{C->S} (c\|\|nₛₑₛₛ) = t | |
| If any fail, abort | |
| j_{c,exp} <- j_{c,exp}+1 | |
| msg <- CBC.Dec K^{E}_{C->S}, r_{c} (d) | |

Specifically, when C wants to send a new message msg to the session identified by UID uₛ, S generates r_{c} from a source of hardware entropy and loads the state associated with the UID. C then sends to S the following: r_{c}∥CBC k^{E}_{C->S},r_{c} (msg)∥uₛ∥j_{c}∥HMAC k^{H}_{C->S} [r_{c}∥CBC k^{E}_{C->S},r_{c} (msg)∥uₛ∥j_{c}∥nₛₑₛₛ]. After sending the message, S increments its held sequence number j_{c}. In the event that incrementing this number would cause an integer overflow to occur, C must delete the state associated with the active session, requiring S to initiate a new one before further communication can proceed.

When S receives a message of this type from C, S first checks if the sent UID uₛ is its UID. If not, S immediately stops and waits for further messages. If the sent UID uₛ is its UID, S performs the following two checks to verify the integrity and authenticity of the received message. First, S checks that the sent sequence number j_{c} matches the stored expected sequence number j_{c,exp}.

Second, S checks that the HMAC sent generated from the first part of the message and its stored value of nₛₑₛₛ associated with the session matches what was sent in the second part of the message. If there is a match, S knows that the received message is valid and increments its value of j_{c,exp} in preparation of the next one. S then uses the received r_{c} to decrypt the AES-CBC-encrypted message and receive the msg inside, handling the contents as desired.

### ARMOR Framework

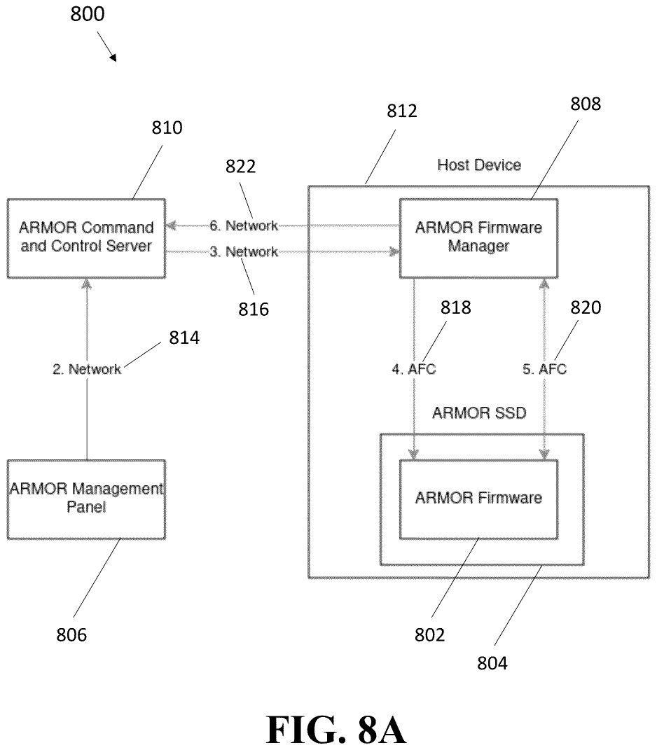

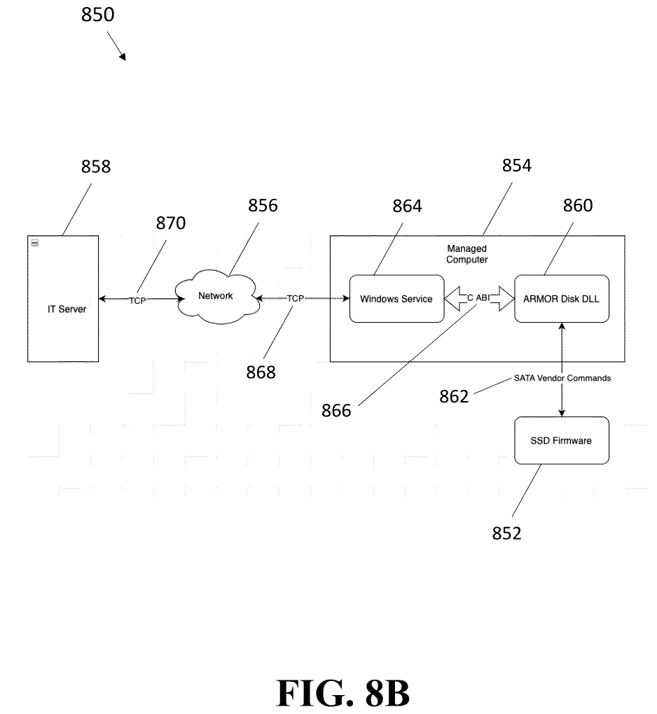

In at least one embodiment, and as shown in FIG. 8A, a system 800 comprises an ARMOR framework that facilitates, in a user-friendly manner, communication and control with ARMOR and/or computing devices on which ARMOR is installed. The at least one embodiment can therefore be implemented as an end-to-end solution. The system 800 has a plurality of aspects and/or components, including ARMOR firmware 802 as described above herein, SSD 804 on which ARMOR firmware 802 is installed, as described above herein, an ARMOR Management Panel (AMP) 806, an ARMOR Firmware Manager (AFM) 808, and an ARMOR Command and Control Server (AC2) 810. The SSD 804 (and therefore the ARMOR firmware 802) and the AFM 808 are here stored on the host device 812.

### Armor Management Panel (AMP)

The AMP 806 is a program or application (e.g., Internet or web application) that provides a user interface to the functionality of AC2 810. Accordingly, AMP 806 communicates with AC2 810 via network 814. In at least one example, AMP 806 allows for monitoring and visualization of ARMOR network status and authorized users to initiate recovery.

In at least one example, AMP 806 comprises (1) a search engine (e.g., Elasticsearch) for searching through large amounts of data, such as system monitoring logs, (2) a data visualization tool (e.g., Kibana) for visualizing the search results obtained by the search engine, and (3) one or more logging programs (e.g., Logstash) that ingest data from sources such as Beats, process the data to a uniform format, and then send the processed data to various data storage locations on the computing devices.

Generally, in operation, various data logging sources send their data to logging programs, which then process and send the data to different sources. The search engine and the data visualization tool are then used to visualize and interpret the data.

Although the aforementioned tools are able to process data in a variety of formats, a scheme (e.g., the Elastic Common Schema (ECS)) may be used to standardize data fields for ease of searching via the search engine. For instance, logging information often contains information about the system the log is coming from, such as the operating system. However, the exact format in which the information is presented may differ. The scheme defines a standard set of common log data fields, such as the host OS. Logging programs or ingestion tools (e.g., Logstash) can then transform the logging data using this standard set of fields, thereby enabling easier searching.

In at least one example, the Elasticsearch, Kibana and Logstash (ELK) stack ecosystem is used. Many of the logging fields are specific to the ARMOR system; accordingly, logging data (e.g., journal status) need not be transformed to ECS fields. The JSON output described above herein may then be ingested to custom ECS fields using Logstash's JSON filter plugin, which converts JSON output to a form usable by Elasticsearch.

### Armor Firmware Manager (AFM)

AFM 808 is a collection of programs that allow host device 812 to communicate with AC2 810 via networks 816, 822. Such communication comprises the execution of commands from AC2 816 and the initiation of queries to AC2 822. The AFM 808 communicates with ARMOR firmware 802 via automated frequency coordination (AFC) 818, 820. In at least one example, AFM 808 has a component running on host device 812 that is configured to query AC2 810 for commands that should be run.

In at least one example, AFM 808 is implemented in a background service (e.g., a Windows background service, which is a long-running executable application that runs in its own Windows session). Thus, in at least one example, the background service can be a Windows service using Microsoft-recommended framework and can be managed through a service manager. The background service may comprise: (1) the service itself, which connects to the IT server and relays requests, and (2) a dynamically linked library, which contains the code (e.g., C++ code) for the low-level SATA commands issued to talk to the drive firmware. In the non-limiting example in which the code is C++ code, the background service itself can be written in C#, meaning that the C++ code is not easily directly run in the background service. However, both C++ and C# are able to inter-operate via calling of C-style functions with C-style structs. This means that any C++ code in the library can be called from C# once wrapped in a C application binary interface (ABI).

In at least one example, one or more programs (e.g., Beats) are run on the computing (host) devices to be monitored 812, for example in AFM 808, and therefore accumulate/return data that can be searched by the search engine of the AMP 806.

FIG. 8B is a diagram 850 showing various components of the aforementioned Windows background service in the context of various ARMOR components. The SSD firmware 852, the managed computing device 854, network 856, and IT server 858 are interconnected. The SSD firmware 852 communicates to ARMOR disk DLL 860 via SATA vendor commands 862. The ARMOR disk DLL 860 and the Windows background service 864, both of which are on computing device 854, communicate with each other through C ABI 866, as described above. The background service 864 communicates with network 856 via TCP 868. Finally, IT server 858 communicates with network 856 (and, by extension, background service 864) via TCP 870.

### ARMOR Command and Control Server (AC2)

AC2 810 is a server that coordinates status tracking of ARMOR firmware-equipped storage devices (e.g., SSD 804) and recovery in the event of a ransomware attack. AC2 can be operated by remote users (e.g., with access provided through the AMP 806) or be self-hosted by the user and/or organization operating ARMOR.

In at least one example, AC2 810 is an Internet server with various Representational State Transfer (REST) endpoints that AFM 808 can query to determine what actions the AFM should take. For instance, for AFM 808 to query the AC2 810 for what command should be run, AFM 808 can make a GET request to a specified endpoint. The response packet from AC2 810 can then be some encoding of what command to run. Similarly, AFM 808 sending a status update to AC2 810 can POST some JSON data to a specified endpoint, which AC2 810 will ingest and process. AC2 810 may, in at least one example, be implemented as a NodeJS stack for the backend (e.g., using the Express library) and a React frontend for the AMP 806.

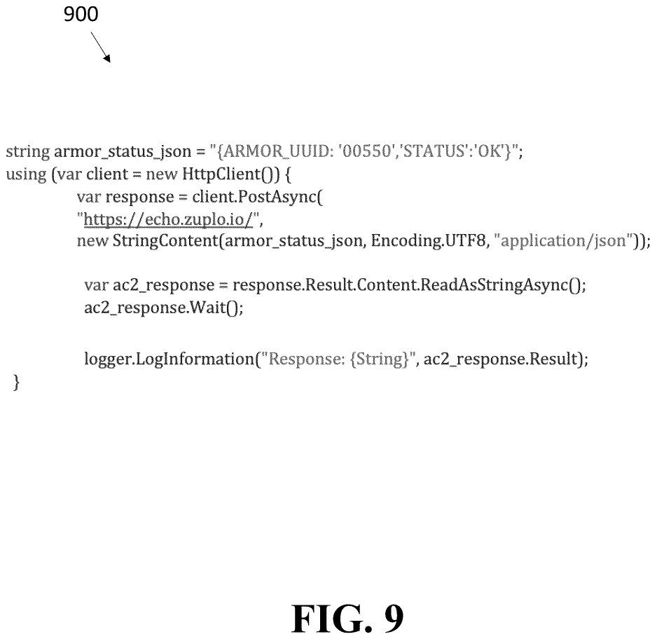

AFM 808 also interacts with the REST API. This can be achieved by using, for instance, standard libraries in C# for performing web requests; making a GET or POST request to either receive or send JSON is therefore straightforward. FIG. 9 shows an example C# code 900 for issuing a POST request with JSON content. The echo.zuplo.io website is one that echoes any request made to it. In this example, the response content is expected to contain the sent JSON armor_status_json.

### Automated Ransomware Detection

In at least one embodiment, ARMOR performs automated ransomware detection and data recovery, in addition to or instead of manual recovery. Automated detection and recovery can close the time gap between the activation of a given ransomware and initiating data recovery in response. ARMOR can perform one or more of the following categories of ransomware detection: (1) signature-based detection, and (2) behavior-based detection.

Generally, signature-based detection relies on comparing bytecode samples from previous ransomware attacks. Although this is effective against previously used ransomware, it may be a poorer option against targeted attacks or new versions of previously used ransomware, which are able to utilize obfuscated or otherwise different bytecode that fails to check against past signatures.

On the other hand, behavior-based detection systems monitor a system for unusual behaviors or statistical anomalies that suggest ongoing ransomware activity. Two such prominent and noticeable features are the entropy (randomness) of data being written to the disk and the process of “overwriting” files.

### Overwrites

Ransomware that utilizes overwriting often read the computer's files, produce encrypted versions of them, and then either overwrite the original files with the encrypted versions or write the encrypted data to new files and delete the old files. The read-write or read-overwrite process thus creates a pattern of rapid access and overwriting or deletion of files.

In contrast, many kinds of normal user activity, such as writing to a word processing document, involve human input and thus the time between file access and overwriting is higher. Even legitimate encryption applications like 7zip, which access files and encrypt them on relatively short notice, are typically limited to localized effects (e.g., a targeted folder being encrypted).

However, ransomware attempts to affect as much of the victim's data as possible, necessitating a search of most of the computer and a subsequent mass-encryption of files. Detecting such a pattern can be done at the OS level, where the files themselves would be accessed and then replaced by an encrypted counterpart. However, access to the file system is not available at the firmware level. Rather, Non-Volatile Memory Express (NVMe) commands can be passed between the SSD and higher-level layers like the OS.

NVMe commands perform numerous functions depending on their opcode, but two relevant opcodes for detecting overwrites are the “read” and “trim” commands. Although a “write” command exists, writing to a file causes the file's old data to be trimmed, while the new data is written elsewhere. Accordingly, at least one embodiment defines an overwrite at the disk level as a “trim” command on an LBA that takes place within a specific period of time (e.g., about 10 seconds) after a “read” command on that LBA.

Traces can be generated and examined using several simulated ransomware, actual ransomware, and typical user behaviors.

### Detection

In at least one example, six metrics are used to determine whether a trace contains evidence of ransomware activity. These six metrics are derived from the SSD-Insider detection mechanism (available at the cs.ucf.edu website) and are calculated for each second of the trace. Each metric is based on overwrites but targets different aspects of ransomware behavior. For instance, the first metric (Frame Overwrites) and the second metric (Window Overwrites) measure the number of overwrites in a current time frame (e.g., the past one second or any other pre-determined time frame) and in a given time window (e.g., the past 10 seconds), respectively. This captures both short-term and medium-term disk behavior, which provides an indication of the overall level of overwrite activity.

Consideration is also given to the average size of every overwrite in the current time window, represented by the third metric (Average Overwrite Length); ransomware generally targets large quantities of files and are thus expected to affect scattered and discontinuous blocks across a disk.

The fourth metric is Window Overwrite Percentage, which is calculated from the number of commands issued to free recently read LBAs over the number of recently issued commands to free any block during the current time window. This metric measures the percentage of commands that are being used to issue overwrites to unique files. Window Overwrite Percentage is expected to be lower for tools like data wiping software that issue similarly high volumes of overwrites but are required to repeatedly clear the same block multiple times, since only the first instance of a trim command on a recently read block is counted as an overwrite. Accordingly, data wiping software will generally issue multiple non-overwrite commands for every overwrite it actually performs.

The aforementioned metrics are joined by short-term and medium-term measurements of the change in the number of overwrites, specifically the Frame Slope (the fifth metric) and Window Slope (the sixth and final metric). The Frame Slope is the number of overwrites made during the current time frame divided by the number of overwrites from the previous time frame. The Window Slope is the number of overwrites made during the current time frame divided by the number of overwrites during the remainder of the time window. Both the Frame Slope and the Window Slope specifically capture the start of ransomware activity, during which the previous few seconds contain comparatively few overwrites until the ransomware suddenly begins attempting to encrypt files in bulk.

In at least one example, overwrites are calculated as a number of instances in which a memory address is freed by a dataset management command within a pre-determined time window (e.g., about ten seconds) after a read command is run on the memory address.

### Machine Learning Model

In at least one embodiment, the aforementioned six metrics are used to train a binary decision tree that labels any given second as either normal behavior or suspicious behavior based on the six metrics for that second.

Generally, a binary decision tree has branch nodes with a conditional statement and leaf nodes with a label. Branch nodes have two child nodes, which may be either other branch nodes or leaf nodes. A binary decision tree usually classifies data points by starting at the root branch node, navigating each branch node by determining whether the node's conditional statement is met or not, and then selecting the appropriate child node. Once a leaf node is reached, the data point is labeled according to the leaf node's label.

Binary decision trees can be created by training from a set of labeled data points. Data points may be collected from ARMOR by running various tasks in a virtualized environment and calculating the six metrics. The tasks may include both running ransomware on the computing system, and benign user activities such as Internet browsing. Data points may be collected, and each trace may be labeled appropriately according to whether the ransomware was run (“suspicious behavior”) or not run (“normal behavior”).

Using a labeled data set generated in this or a similar way, a binary decision tree may be generated according to at least one embodiment through a greedy algorithm minimizing Gini impurity as follows.

Data: S={(x1,y1), . . . , (xn,yn)},yi∈{1, . . . , c}, where c is the number of classes

Let Sk⊆S where Sk={(x,y)∈S:y=k} (all inputs with labels k)

S=S|∪ . . . ∪Sc

### Define:

$$pk = \vert Sk ‖ S \vert ← fraction of inputs in S with label k$$

The Gini impurity of a leaf G(S) is:

$$G ( S ) = \sum k = 1 cpk ( 1 - pk )$$

The Gini impurity of a tree GT(S) is:

$$GT ( S ) = \vert SL ‖ S \vert GT ( SL ) + \vert SR ‖ S \vert GT ( SR )$$

where:
(S=SL∪SR)
SL∩SR=Ø
   |SL∥S|←fraction of inputs in left sub-tree
   |SR∥S|←fraction of inputs in right sub-tree

Let p1, . . . , pk be defined as before. Uniform Distribution: p1=p2= . . . =pc=1c. This is the worst case since each leaf is equally likely. Prediction is random guessing. Define the impurity as how close one is to uniformity. Use KL-Divergence to compute “closeness”
Note: KL-Divergence is not a metric because it is not symmetric, i.e., KL (p∥q)≠KL(q∥p).

Let q1, . . . , qc be the uniform label/distribution. i.e. qk=1c∀k

$$K L ( p ‖ q ) = \sum k = 1 cpk log pkqk \geq 0 ← KL - Divergence$$

$$= \sum kpk log ( pk ) - pk log ( qk ) where qk = 1 c$$

$$= \sum kpk log ( pk ) + pk log ( c )$$

$$= \sum kpk log ( pk ) + log ( c ) \sum kpk where log ( c ) ← contstant , \sum kpk = 1$$

$$max pKL ( p ‖ q ) = max p \sum kpk log ( pk )$$

$$= min p - \sum kpk log ( pk )$$

$$= min pH ( s ) ← Entropy$$

### Entropy Over Tree:

$$H ( S ) = pLH ( SL ) + pRH ( SR )$$

$$pL = \vert SL ‖ S \vert , pR = \vert SR ‖ S \vert$$

In at least one embodiment, ARMOR utilizes a binary decision tree created in the above manner, with points containing the aforementioned six metrics and the labels “suspicious behavior” and “normal behavior.”

In at least one example, if the number of “suspicious behavior” decisions in the current time window exceeds a threshold (e.g., between about 20% to about 40%, preferably 30%), the trace is considered to be a ransomware trace. Decisions made for each data point are explainable by observing the nodes of the trained tree and comparing them to the values of the data point. For example, if a branch node on the tree leads to a leaf node labeled “suspicious” when Frame Overwrites are high, then if that branch node is reached and the current activity was declared to be suspicious, then it follows that there were a large number of overwrites within the past second.

Finally, if the current trace is determined to exhibit behavior indicating a potential ransomware attack, the next method (entropy) may be engaged. The entropy method, as described below, reduces false positives by detecting encryption and file changes through the entropy of write data sent to the SSD.

### Entropy

The overwrite-based method described above herein may become reliant on recent overwrites, which can only monitor disk activity at a summary statistic level and may not account for the content being written to the disk. Since ransomware renders a victim's data unusable, files are usually encrypted with a robust algorithm to avoid the possibility of a victim recovering their own data by discovering a way to decrypt these files. For example, TeslaCrypt uses the AES-256 algorithm, while WannaCry uses the related AES-128.

These and other similar algorithms output effectively random bytes so that attempting to decrypt files without the encryption key is as difficult as possible. However, this characteristic opens up the ransomware to analysis based on the data being written to the disk. While encrypted files are highly random, files that contain raw information such as text are prone to repeating certain bytes, e.g., the encoding values for letters and numbers.

At least one embodiment of the invention uses entropy-based ransomware detection, which exploits this difference by observing when the disk is being requested to create a large number of files that may be encrypted. Generally, the process of using entropy as a way to detect ransomware can require examining large amounts of data, at least in comparison to overwrite-based detection, which usually only requires basic information about the disk's read and write operations.

In at least one embodiment, entropy checks are implemented only on writes that are considered suspicious by overwrite-based detection, as described above. Accordingly, more computationally expensive entropy checks are reduced. Computational burden can be further eased by using less intensive tests instead of, e.g., calculating Shannon entropy. In at least one example, the Cumulative Sums test (available at the nvlpubs.nist.gov website) is used at a threshold of 0.01 to determine if a particular write's data was random or not, with p-values lower than 0.01 being considered non-random.

Additionally, relying on both overwrites and entropy rather than one or the other makes false positives less likely. Although high-entropy files may occasionally be legitimately downloaded, the presence of traces that fail both an overwrite check and have high entropy means that the disk is finding files and replacing them with encrypted versions, which is likely to be from ransomware behavior.

Further, many files that are targeted by ransomware, such as, for instance, text, source code, spreadsheets, and the like, begin as low-entropy files. Such files only become high-entropy when encrypted. This pattern is unlikely to be replicated by most other (legitimate) processes at scale, since a process that is continually operating is more likely to be overwriting its data with new data of a similar entropy (e.g., a text file automatically saving over itself). A “write” is therefore defined, in at least one embodiment, to be low-to-high entropy if the value of the Cumulative Sums test on the previous data was less than 0.01 (that is, unlikely to be random data), while the newly written data has a result greater than 0.01 (that is, likely to be random data).

In at least one example, the entropy checks comprise calculating a rate of low-to-high entropy writes occurring over a pre-determined period of time (e.g., about one second). If the rate exceeds about 0.2, malicious activity/ransomware is likely present.

### Computing Systems

One or more of the embodiments described herein can be implemented on one or more computing systems, as described in further detail below.

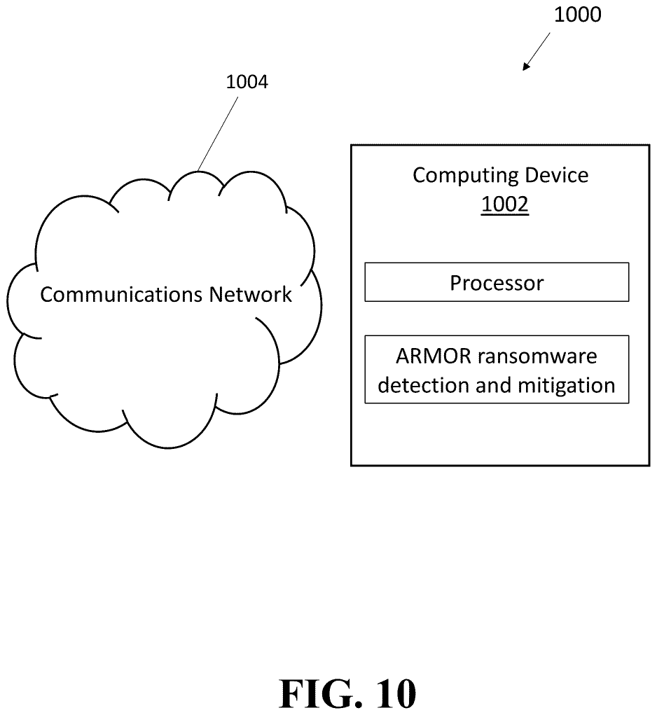

FIG. 10 is a block diagram of a computing system 1000 for detecting and/or mitigating ransomware, according to an example embodiment. Thus, the computing system 1000 may comprise, for instance, any one or more components of ARMOR described herein. The system 1000 comprises one or more computing devices 1002 that contain ARMOR ransomware detection and mitigation functions and/or firmware. These ransomware detection and mitigation functions can further be capable of scheduled or triggered communications or commands when various events occur (e.g., when prospective ransomware is discovered, when one or more errors with the functioning of one or more ARMOR components occurs, etc.).

The one or more computing devices 1002 can be used to store acquired images, graphs, textual data, and/or computational data, as well as other data in memory and/or a database. The memory may be communicatively coupled to one or more hardware processing devices.

The one or more computing devices 1002 may further be connected to a communications network 1004, which can be the Internet, an intranet, or another wired or wireless communications network. For example, the communications network 1004 may include a Mobile Communications (GSM) network, a code division multiple access (CDMA) network, 3rd Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

The one or more computing devices 1002 include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of ARMOR's ransomware detection and/or mitigation. In addition, the one or more computing devices 1002 further include at least one communications interface to transmit and receive communications, messages, and/or signals.

Thus, information processed by the one or more computing devices 1002, or the one or more applications executed thereon, may be sent to another computing device, such as a remote computing device, via the communication network 1004.

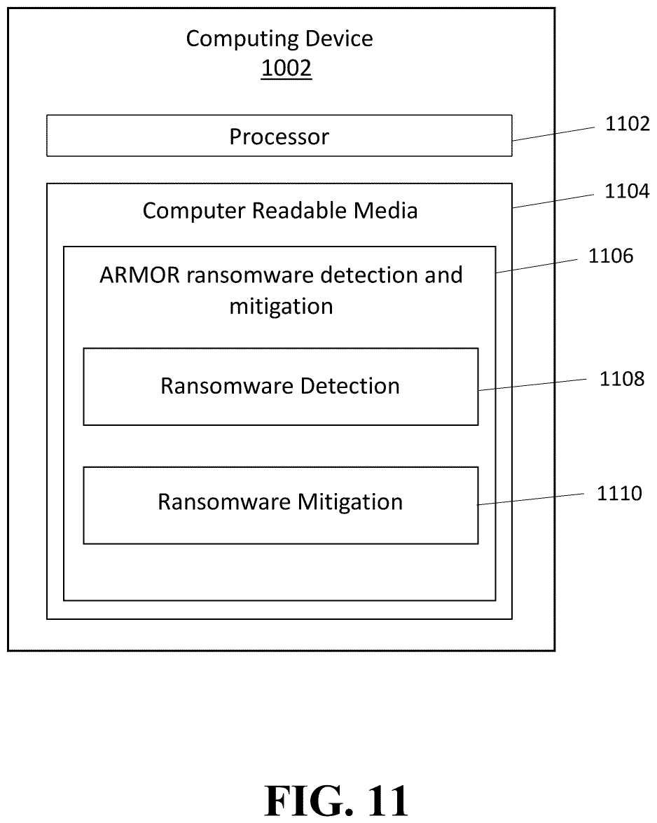

FIG. 11 is a block diagram of a computing device 1002 according to an example embodiment. The computing device 1002 includes computer readable media (CRM) 1104 in memory on which one or more ARMOR ransomware detection and mitigation functions 1106 are stored. The computer readable media may include volatile media, nonvolatile media, removable media, non-removable media, and/or another available medium that can be accessed by the processor 1102. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

ARMOR ransomware detection and mitigation functions 1106 include ransomware detection 1108 and ransomware mitigation 1110 (including, for instance, data recovery functions) as discussed above. ARMOR ransomware detection and mitigation functions 1106 may also be operable to obtain data from one or more other computing devices, computing systems, and/or servers, and to process, analyze, review, correct, and/or store that data that data.

Using a local high-speed network, the computing device 1002 may receive the aforementioned data in near real time from one or more of the abovementioned modalities and/or components, process the data, and generate one or more calculations, graphs, diagrams, and/or analyses (including, for instance, decision trees, machine learning models, and the like). These calculations may be executed by one or more algorithms within the ARMOR ransomware detection and mitigation functions 1106 or other applications.

Measured or calculated data may be monitored to generate an event and an alert if an error occurs or if measured or calculated data is out of range. Such alerts may be sent in real-time or near real-time using an existing uplink or dedicated link. The alerts may be sent using email, SMS, push notification, or using an online messaging platform to end users and computing devices, among others.

ARMOR ransomware detection and mitigation functions 1106 may enable data visualization as described above herein. Such visualization may, in at least one example, be provided via a native and/or web-based graphical user interface (GUI) that accepts input and provides output viewed by users of the computing device 1002. The computing device 1002 may provide real-time automatically and dynamically refreshed information on the detection and/or mitigation of ransomware, and/or the functioning of ARMOR or one or more components therein. The user interface module may send data to other computing devices, computing systems, and/or servers, and retrieve data therefrom asynchronously without interfering with the display and behavior of the user interface.

Thus, information processed by the computing device 1002, or by ARMOR ransomware detection and mitigation functions 1106 and/or one or more other applications, may be sent to another computing device, such as a remote computing device, via the communications network 1004.

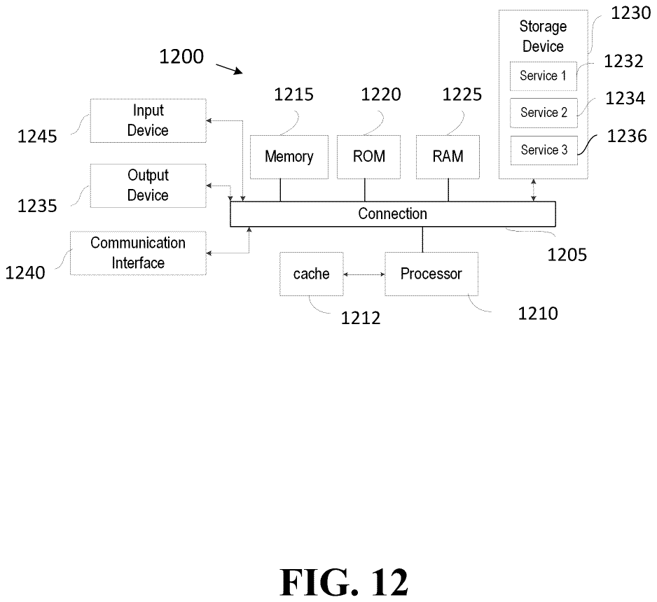

FIG. 12 shows an example of computing system 1200, which can be for example any computing device such as the computing device 1002, or any component thereof in which the components of the system are in communication with each other using connection 1205. Connection 1205 can be a physical connection via a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache of high-speed memory 1212 connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Storage device 1230 may be, in at least one example, storage (e.g., SSD) containing ARMOR firmware, and services 1232, 1234, and/or 1236 are ransomware detection and/or mitigation services. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art. In some instances, multimodal systems can enable a user to provide multiple types of input/output to communicate with computing system 1200. Computing system 1200 can include communications interface 1240, which can generally govern and manage the user input and system output. There is no restriction on operating on any particular hardware arrangement, and therefore the basic features here may easily be substituted for improved hardware or firmware arrangements as they are developed.

Storage device 1230 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

For clarity of explanation, in some instances, the present technology may be presented as including individual functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the disclosures herein can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

In summary, embodiments of the disclosure described herein provide a highly effective end-to-end technology solution that mitigates the threat of ransomware across a wide range of devices including, for instance, servers, storage systems (e.g., cloud storage), computers, and other portable storage devices (e.g., smartphones, tablets, USB devices, etc.). Further, one or more aspects and/or steps of the ransomware mitigation methods, devices, and/or systems may operate, and/or be executed, below a level of a computer operating system or system processor. For instance, such one or more aspects and/or steps may be executed by a computer processor of a data storage device.

These and other objectives and features of the invention are apparent in the disclosure, which includes the above and ongoing written specification.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

What is claimed is:

1. A non-transitory computer-readable storage medium, having instructions stored thereon that, when executed by a computing device, cause the computing device to perform operations, the operations comprising:
logging requests to write data to a storage device of the computing device to a data journal;
determining when a malicious attack has occurred on the computing device; and
when it has been determined that the malicious attack has occurred, restoring original data to the storage device from the data journal,
wherein the instructions stored on the non-transitory computer-readable storage medium operate below the level of an operating system of the computing device.

2. The non-transitory computer-readable storage medium of claim 1, wherein the restoring the original data further comprises:
redirecting all attempted reads and writes to a first Extensible Firmware Interface (EFI) System Partition (ESP) in a regular flash area of the storage device to a second ESP, which is a recovery ESP, in a hidden flash area of the storage device, such that an attempt to read a first logical block of the first ESP instead receives a first block of the recovery ESP;
dynamically adding an entry to into a GUID Partition Table (“GPT”) for recovery OS data, stating that a data partition exists in an extent of logical blocks; and
redirecting any reads or writes to the extent of logical blocks to a hidden recovery OS data partition on the storage device.

3. The non-transitory computer-readable storage medium of claim 1, wherein the restoring the original data further comprises:
reading the data journal;
determining whether writes from the data journal are either compromised or unaffected;
determining, for the compromised writes, a correct disk state for each Logical Block Address (LBA) corresponding to one of the compromised writes; and
correcting, by the data journal, a disk state of the storage device to the correct disk state.

4. The non-transitory computer-readable storage medium of claim 1, wherein the restoring the original data further comprises:
querying firmware of the data journal for a list of recovery points and selecting a recovery point from the list of recovery points;
querying, from the data journal firmware, entire contents of the data journal;
storing each Logical Block Address (LBA) that was overwritten by a write corresponding to a data journal entry after the recovery point as a compromised LBA;
for each compromised LBA, iterating backward through a portion of the entire contents of the data journal that occurred before the recovery point to find a most recent journal entry that wrote to the compromised LBA; and
for each compromised LBA, issuing commands to the data journal firmware to restore the compromised LBA to data written by the most recent journal entry that wrote to the compromised LBA, thereby restoring each compromised LBA to an uncompromised state.

5. The non-transitory computer-readable storage medium of claim 1, wherein, for every request in the requests to write data, the data journal records (i) a logical block address (LBA) of the storage device that is written, (ii) a copy of the original data at the LBA that is overwritten, and (iii) an increasing count of a number of writes made.

6. The non-transitory computer-readable storage medium of claim 5, wherein the logged requests are stored in a ring buffer.

7. The non-transitory computer-readable storage medium of claim 1, wherein the data journal comprises:
a first section containing metadata about the data journal;
a second section containing metadata associated with the data requested to be written; and
a third section containing a copy of the data requested to be written.

8. The non-transitory computer-readable storage medium of claim 1, the operations further comprising:
protecting, by a cryptographic scheme, communications between the non-transitory computer-readable storage medium and the storage device,
wherein the cryptographic scheme comprises symmetric-key encryption and symmetric-key message authentication codes as primitives with replay resistance.

9. The non-transitory computer-readable storage medium of claim 8, the cryptographic scheme further comprising session-based synchronization and acknowledgement messages.

10. The non-transitory computer-readable storage medium of claim 8, wherein the operations further comprise:
establishing a communication channel between the non-transitory computer-readable storage medium and a remote information technology (IT) server,
wherein the communication channel is (i) encrypted, (ii) authenticated with respect to messages between the storage device and the remote IT server, and (iii) reply-resistant between the storage device and the remote IT server such that the malicious attack cannot represent to the remote IT server that the computing device is uncompromised.

11. The non-transitory computer-readable storage medium of claim 10, wherein both the remote IT server and the non-transitory computer-readable storage medium have a shared, identical cryptographically random key.

12. The non-transitory computer-readable storage medium of claim 1, wherein the determining when the malicious attack has occurred further comprises:
calculating overwrites to the storage device as a number of instances in which a memory address is freed by a dataset management command in a pre-determined time window after a read command is run on the memory address.

13. The non-transitory computer-readable storage medium of claim 12, wherein the pre-determined time window is about ten seconds.

14. The non-transitory computer-readable storage medium of claim 12, wherein the calculating overwrites further comprises:
calculating a set of metrics to determine whether a trace contains evidence of the malicious activity,
wherein the set of metrics comprise (i) a number of overwrites in a given time frame, (ii) an average size of the overwrites in the given time frame, (iii) a percentage of commands used to issue the overwrites in the given time frame, and (iv) the number of overwrites in the given time frame divided by a number of overwrites from a previous time frame before the given time frame.

15. The non-transitory computer-readable storage medium of claim 14, wherein the operations further comprise:
training, by the calculated set of metrics, a binary decision tree that labels any given second as either normal behavior or suspicious behavior based on the calculated set of metrics for the given second.

16. The non-transitory computer-readable storage medium of claim 15, wherein determining when a malicious attack has occurred on the computing device comprises calculating entropy of writes during a given second labeled as suspicious behavior by the binary decision tree, and confirming malicious activity when a ratio of low-to-high entropy writes to total number of writes occurring over the given second labeled as suspicious behavior exceeds 0.2.

17. The non-transitory computer-readable storage medium of claim 1, wherein determining when a malicious attack has occurred on the computing device comprises:
analyzing file overwrites; and
calculating entropy of data being written to the computing device.

18. The non-transitory computer-readable storage medium of claim 17, wherein the calculating the entropy further comprises:
calculating a rate of low-to-high entropy writes occurring over a pre-determined period of time; and
determining that the malicious activity has occurred when the rate exceeds 0.2.

19. The non-transitory computer-readable storage medium of claim 18, wherein the pre-determined period of time is about one second.

20. The non-transitory computer-readable storage medium of claim 18, wherein the calculating the entropy further comprises:
identifying at least one write as low-to-high entropy when a value of a Cumulative Sums test on the data being written is greater than 0.01 while a value of the Cumulative Sums test on previous data is less than 0.01.

21. The non-transitory computer-readable storage medium of claim 1, wherein the non-transitory computer-readable storage medium is in the storage device.

22. A system comprising:
a computing device comprising a storage device and a non-transitory computer-readable storage medium having instructions stored thereon that, when executed by the computing device, cause the computing device to perform operations, the operations comprising detecting and mitigating malicious activity on the computing device;
a command-and-control server that coordinates status tracking of the storage device and recovery of the computing device;
a firmware manager that permits the computing device to communicate with the command-and-control server and issue data restoration commands to the non-transitory computer-readable storage medium to restore data in the storage device; and
a management panel to provide a user interface to functionality of the command-and-control server including monitoring status of the storage device and initiating recovery of the computing device after occurrence of the malicious activity.

23. The system of claim 22, wherein the firmware manager is implemented in a background service comprising a Dynamic Linked Library (DLL) configured to allow the background service to communicate with firmware of the storage device.

24. The system of claim 22, wherein the operations further comprise encapsulating communications between the non-transitory computer-readable storage medium and the command-and-control server in a protocol that can be read and acted upon by the command-and-control server to effectuate the recovery of the computing device.

25. The system of claim 22, wherein the non-transitory computer-readable storage medium resides in the storage device.
